(19) United States
(12) Patent Application Publication
(10) Pub. No.: US 2007/0147703 A1
(43) Pub. Date: Jun. 28, 2007

(54) Blending a digital image cut from a source image into a target image

(75) Inventors: Alistair I. Watson, Dunblane (GB); William F. Gallafent, Bedfordshire (GB)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: BOURBAY LIMITED, London (GB)

(21) Appl. No.: 10/566,526

(22) PCT Filed: Jul. 30, 2004
(86) PCT No.: PCT/GB04/03336

§ 371 Date: Sep. 22, 2006

(30) Foreign Application Priority Data
Aug. 1, 2003 (GB) 0318129.4

(51) Int. Cl. G06K 9/36

(52) U.S. Cl. 382/284

(57) ABSTRACT

Method for blending a foreground object of a first image into a second image in which the transition boundary region between the foreground object and the background comprises a linear color transition based on the colors of the foreground object and the background, respectively.

In recent years, vast strides have been made in the field of computer-assisted image processing. The creation and manipulation of images has proved a boon to many engaged in the graphic arts field, industrial monitoring, and surveillance, but there are still problems in the initial stages of rendering an already existing image into processable form. The classic approach to securing a computerised image is to scan a photographic original to form a file in which data are-stored representing properties of a large number of portions of the image, so-called pixels. Each pixel is characterised by a number of parameters corresponding to colour and intensity. The file also contains data relating to the location of each pixel so that, when the file is called up by an appropriate program, the image is displayed on screen. More recently, the process of scanning has been supplemented by the development of so-called digital cameras, which produce an image file directly.

The invention is related to the insertion of an image, cut out from a source image A, into a target image B to form a so-called composite image. The source image needs firstly to be broken down into different areas corresponding to the image to be cut out and the remainder. The method of segmenting an image using the watershed method, as outlined in patent WO 03/052696, enables accurate identification of the edges of an object in the source image. The pixels which form the object to be cut out are labelled “foreground”, and those forming the boundary or boundaries of the object are called “edge” pixels. The remaining pixels in the source image are labelled “background”.

Many automated methods of segmentation are based upon the assumption that, within an image, at the edge of an object the digital values associated with each of the pixels change substantially from one pixel to the next. However, the changes that do occur at the edge of an object may extend over many pixels away from an edge (e.g. unfocussed edges, hair, fur). Thus, the pixels forming the edge of a foreground object are “mixed” in the sense that they contain colour information from both the foreground and the background of the image. By defining a quantitative “opacity” of a mixed pixel as the proportion of that pixel's colour derived from the foreground of the original image, this quantity can be used in the context of an image mask to super-impose an abstracted image onto a new background.

In order to provide satisfactory integration of the cut-out object into a target image, the contribution from the background of the source image must be removed from the mixed colour data for the edge pixels, and replaced with corresponding information from the target image. This may be accomplished by using local and global colour information to determine the proportion of foreground colour in a given edge pixel, and hence enabling an opacity value and a pure (foreground) colour to be assigned to it. Then for each edge pixel, the foreground colour of the original may be blended with the background of the target image to create a mixed pixel for eventual use in the composite image.

It is assumed that each edge pixel has a digital colour value that is a mixture of the colours of an adjacent or nearest object pixel or set of pixels and an adjacent or nearest set of background pixels. It is usually possible to find object and background pixels in the neighbourhood of a given edge pixel, by searching the neighbouring pixels, starting from those adjacent and gradually expanding the search until a predetermined termination point is reached. The mean colours of the object and background pixels found can then be used to determine the opacity of the edge pixel, by applying vector algebra in colour space.

In particular, taking the point in colour space on the line drawn between the background and foreground colours which is closest to the colour of the mixed pixel, the opacity is proportional to the distance from this point to the background colour divided by the distance between the foreground and background colours.

As each edge pixel is processed, the colour values assigned to it are accordingly reset to be those of the object colour that was used to determine its opacity fraction. Thus the colour of the mixed pixel in the composite image to be constructed by compositing the object part of the source image A onto the new background of the target image B will be a mixture of the pure object colour with the new background colour; the influence of the original background colour from the source image A is completely removed.

If there is a failure to find object and/or background pixels within the preset limits of the search, then the colours of the object and/or background in the whole source image are scanned to find the pair of colours that gives the fractional composition approximating most closely to the colour of the edge pixel, again using vector algebra in colour space. In brief, a set of colour classes (from the colour watershed based classification and segmentation) which occur only in the foreground is generated, and is then reduced to include only classes which occur in regions which are adjacent to regions on the edge of the foreground area of the image. The modal colour of each class present in that set of regions is taken as being a candidate foreground colour, and a set is thus formed of potential foreground colours. A similar process finds a set of candidate background colours. Appropriate foreground and background colours are chosen by minimising the distance in colour space between the candidate mixed pixel and a line drawn between (each of) the foreground colour(s) and (each of) the background colour(s). The colour of the mixed pixel is reset to be that which was chosen as the foreground endpoint of the line in colour space, and the opacity is calculated as before.

Finally, the opacity data is used to construct an image mask, in which object pixels are assigned full opacity and each edge pixel has the opacity corresponding to the contribution to its colour from the foreground. The background pixels are assigned full transparency. The object can then be super-imposed over a target image B according to the mask value. Where the mask is transparent no change to the target image is made. Where the mask is opaque the target image pixel values are replaced with the object pixel values. Where the mask has an,intermediate opacity value, that fraction of the object pixel colour is combined with the complementary fraction of the target image pixel colour.

The following examples will serve to illustrate how the invention may be put into practice, these refer to the accompanying drawings in which:

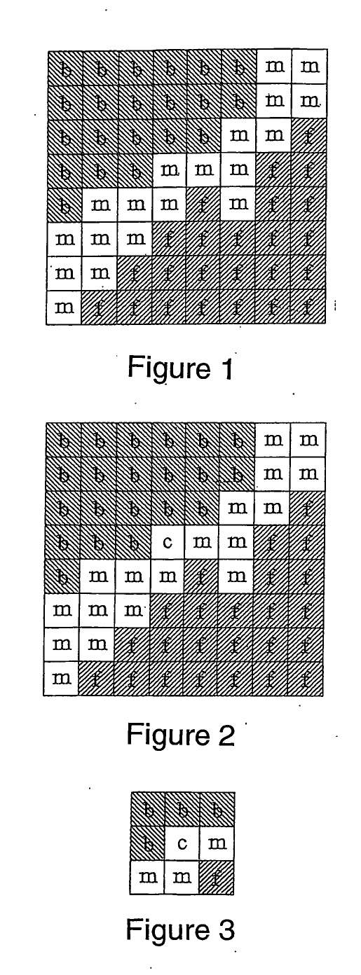

FIG. 1 is a sample edge region of an image,

FIG. 2 is as FIG. 1 but showing a candidate pixel,

FIG. 3 is a diagram of the immediate surroundings of the candidate pixel,

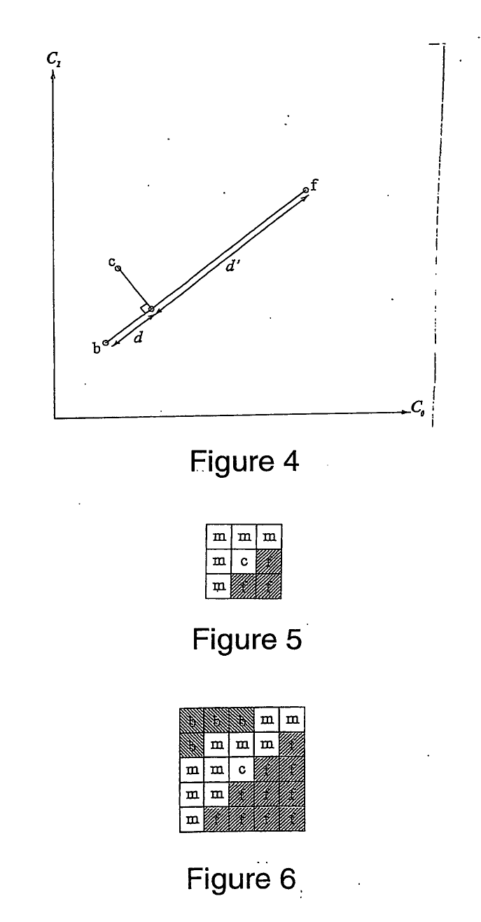

FIG. 4 is a diagram in colour space illustrating the determination of the opacity value for the candidate pixel,

FIG. 5 is a diagram of the immediate surroundings of a more difficult candidate pixel, and

FIG. 6 is a diagram as FIG. 5 but showing more of the surroundings of the candidate pixel.

FIG. 1 shows a small region of an image's status, containing background b, foreground f and mixed m pixels. As the blending process takes place, each m pixel is considered, and local knowledge is used when possible to determine appropriate foreground and background colours to use as blending endpoints.

FIG. 2 shows the same region. The first step is to consider the immediate region of the candidate pixel c. Initially, all the pixels immediately adjacent to c are examined.

FIG. 3 shows all the pixels which will initially be considered. In fact, in this first example, this is as far as the examination goes: there are four b pixels, so their mean colour will be used as the background endpoint for the blending process. There is one f pixel; whose colour will both be assigned to the c pixel, and used as the foreground endpoint.

FIG. 4 shows the line in colour space joining the background pixel b and the foreground pixel f. Let p be the closest point on this line to the candidate pixel c. The opacity value a to assign to the mask in the location of c is defined as the ratio of the distance d from p to b and the total distance between b and f,

$$α = \frac{d}{d + {d}^{′}} = \frac{\vert {bc}^{->} \vert cos θ}{\vert {bf}^{->} \vert} ,$$

using elementary trigonometry, where θ is the angle between bc and bf.

Using the definition of scalar product, (Ref: M. L. Boas, Mathematical Methods in the Physical Sciences, 2nd ed. Wiley, 1983 or any linear algebra book)
\vec{bc}·\vec{bf}=|\vec{bc}||\vec{bf}|cos θ,
the formula for the opacity value becomes

$$α = \frac{{bc}^{->} \cdot {bf}^{->}}{{\vert {bf}^{->} \vert}^{2}}$$

If it turns out that the closest point on the line to c does not lie between b and f, in other words, if 0≦a≦1 is false, then the status of c is changed from m to f (if α>1), or b (if α<0), and a is set to 1 or 0 respectively.

The following example concerns a less easily analysed situation, related to a different candidate pixel selected from the same small area of an image as before.

FIG. 5 shows the immediately adjacent pixels to this new candidate. It is clear that, though three foreground pixels are present, and so a foreground endpoint can be determined by taking their mean colour, there are no adjacent background pixels available. The solution is to look further.

FIG. 6 shows the pixels adjacent to c, and those adjacent to them. There are now pixels of both background and foreground in scope, so the endpoints can be found. They will be the mean colour of the four background pixels, and the mean colour of the ten foreground pixels.

If an endpoint were still missing after this, the region could be expanded again, etc. It is prudent to limit this expansion to a maximum size to allow for realistic processing times. This does introduce the possibility that the process will terminate for a given pixel without having successfully calculated the opacity and colour for that pixel.

There are several ways to escape from this situation. A multi-pass approach is taken, so that if the process fails on the first pass over the image for a pixel, that pixel is left unprocessed for the time being, and awaits the second pass.

During the second and subsequent passes, the system is extended to increase the likelihood of a successful result for each pixel. This is done in two ways:
The limit upon the size at which the search is terminated is increased with each pass. The hope is that the increased processing time per pixel is offset by the presence of fewer pixels to process, and the increased likelihood of success on this pass if a larger area is used.
As well as searching for nearby f and b pixels, nearby rn pixels which have been successfully processed in a previous pass are used. If the f and b based method fails, either or both of the endpoints which were used to process any nearby successful ms may be used as a substitute, being averaged in the same way as fs and bs to generate an endpoint for this candidate.

This repeated passing over the image should lead eventually to all the pixels having been processed. However, to ensure that the computation will be completed within a reasonable time, after a certain time, or once each pass is having success with only a small proportion of the remaining pixels, a final improvement is made which guarantees the completion of the blending process for every pixel.

Having used up to now only local information to determine the endpoints, global information from the image's classification and segmentation are now introduced. The current method is as follows, though variations or other sensible ways of generating the data from the assignments in an image are possible:
1. From the watershed division of the colour space and the status assignment of every pixel in the image, generate a set of colour classes which occur only in the foreground, and segment the foreground into regions, each region being formed from adjacent pixels having the same colour class.
2. Form a set R′ consisting only of the non-edge regions in R, i.e. discard those regions which have adjacent pixels of different status.
3. Form a set of R″ consisting only of the non-edge regions in R, i.e. discard those regions which have adjacent pixels of a different status.
4. Intersect C with C″. This usually gives a small number of foreground colour classes.
5. If the resulting set of colour classes is empty, use in its place the set of colour classes obtained by undertaking C and C′, where C′ is the set of colour classes occurring in R′.
6. If the set is still empty, use the set of all foreground-only colour, classes C.
7. Finally, determine the modal colour of each class/region, and thus generate a list of potential colours to use as foreground endpoints.

A similar process generates a set of potential background endpoints. Now that these extra sets of colours are available, there is a final solution if the methods based only on nearby pixels fail. Essentially, for each endpoint that has not been found, each member of the corresponding set of potential endpoints is tried, and that which minimises the shortest distance between c and bf is chosen. This distance is given by

$$\frac{\vert {bf}^{->} \times {bc}^{->} \vert}{\vert {bf}^{->} \vert} .$$

1-4. (canceled)

5. A method for processing a digital image comprising the steps of:
identifying first and second sets of pixels corresponding respectively to first and second regions of the image;
identifying a third set of pixels corresponding to a third region of the image at the boundary between the first and second regions;
determining a contribution factor for a candidate pixel in the third set of pixels representing the contribution to the visual characteristics of the first and second regions, in which the contribution factor is determined using the visual characteristics of the candidate pixel and the visual characteristics of pixels in the neighborhood of the candidate pixel belonging to the first and second sets of pixels.

6. The method of claim 5 in which the pixels in the neighborhood of the candidate pixel comprise those pixels that are within a certain distance from the candidate pixel.

7. The method of claim 6 in which the distances may be varied.

8. The method of claim 5 in which the visual characteristics of each pixel are representable by a set of values, and in which the contribution factor is determined from first, second and third sets of values, the first set of values being derived from the sets of values representing the visual characteristics of pixels in the neighborhood of the candidate pixel belonging to the first set of pixels, the second set of values being derived from the sets of values representing the visual characteristics of pixels in the neighborhood of the candidate pixel belonging to the second set of pixels, and the third set of values being the set of values representing the visual characteristics of the candidate pixel.

9. The method of claim 8 in which the first set of values is the average of the sets of values representing the visual characteristics of the pixels in the neighborhood of the candidate pixel belonging to the first set of pixels.

10. The method of claim 8 in which the second set of values is the average of the sets of values representing the visual characteristics of the pixels in the neighborhood of the candidate pixel belonging to the second set of pixels.

11. The method of claim 8 comprising the further step of determining a set of classes of visual characteristics which occur only in the first region of the image and which occur in regions of the image which are adjacent to the third region of the image, in which the first set of values is the set of values representing the modal visual characteristics of a selected class of visual characteristics.

12. The method of claim 8 comprising the further step of determining a set of classes of visual characteristics which occur only in the second region of the image and which occur in regions of the image which are adjacent to the third region of the image, in which the second set of values is the set of values representing the modal visual characteristics of a selected class of visual characteristics.

13. The method of claim 1 1 or 12 in which the selected class of visual characteristics is that which minimizes the quantity d, where
$$d = \frac{\vert ( \underline{f} - \underline{b} ) \times ( \underline{c} - \underline{b} ) \vert}{\vert \underline{f} - \underline{b} \vert}$$
where f, b and c are the vectors whose components are respectively the first, second and third sets of values.

14. The method of claim 8 in which the contribution factor is given by the equation
$$α = \frac{( \underline{c} - \underline{b} ) \cdot ( \underline{f} - \underline{b} )}{{\vert ( \underline{f} - \underline{b} ) \vert}^{2}}$$
where α is the contribution factor and f, b and c are the vectors whose components are respectively the first, second and third sets of values.

15. The method of claim 5 in which the contribution factor is an opacity factor.

16. The method of claim 5 in which the visual characteristics include color.

17. The method of claim 5 in which the first region of the image is a foreground portion of the image and the second region of the image is a background portion of the image.

18. The method of claim 5 comprising the further steps of:
modifying the visual characteristics of the third set of pixels according to the contribution factor; and
overlaying the first and third sets of pixels onto a second digital image, the visual characteristics of the overlaid pixels corresponding to the first set of pixels being the same as the visual characteristics of the first set of pixels, the visual characteristics of the overlaid pixel corresponding to the third set of pixels being derived from the contribution factor, the visual characteristics of the pixels onto which the third set of pixels were overlaid and the visual characteristics of the third set of pixels.

19. A system for processing a digital image arranged to undertake the method of claim 5.

20. A method of digital image processing in which an object is excised from a first digitized image and pasted on to a second digitized image, the method including the steps of
identifying a set of pixels corresponding to the object, and within that set which pixels correspond to the edge(s) of the object and which to the interior, for each pixel corresponding to the edge(s) of the object assigning a contribution factor dependent upon the parameters associated with its immediate neighbors including other edge pixels, pixels corresponding to the interior of the object and peripheral background pixels corresponding to the parts of the first digitized image which lie outside the excised object but adjacent its edge(s),
substituting for the parameters associated with each edge pixel of the set parameters based on the contribution factor and on the parameters associated with the peripheral background pixels of the second digitized image,
and constructing a new digitized image file from the pixels of the second digitized image not located at positions corresponding to the pixels of the excised object, the pixels of the interior of the object, and the edge pixels with substituted parameters.

21. A method according to claim 20 wherein the contribution factor is calculated by a method including locating in color space a first point corresponding to the color of pixels adjacent or near the respective edge pixel and assigned to the set of interior pixels,
a second point corresponding to the color of pixels adjacent or near the respective edge pixel and being peripheral background pixels,
and calculating the contribution factor dependent upon the position along the line of the point on the line in color space connecting the first point and the second point closest to the point in color space corresponding to the edge pixel for which the contribution factor is to be calculated.

22. A method according to claim 21 where the contribution factors for the edge pixels are first calculated for all edge pixels in respect of which the surrounding eight pixels include both interior pixels and peripheral background pixels, thereafter for those of the remaining edge pixels in respect of which the surrounding 24 pixels include both interior pixels and peripheral background pixels, and, in respect of any still incalculable pixels; taking into account a great number of pixels surrounding the respective edge pixel.
